(19) United States
(12) Patent Application Publication
(10) Pub. No.: US 2018/0016896 A1
(43) Pub. Date: Jan. 18, 2018

(54) Assessing Permeability

(71) Applicants: GEOISOCHEM CORPORATION, Covina, CA (US); ARROWGRAND TECHNOLOGIES LLC, Covina, CA (US)

(72) Inventors: Yongchun Tang, Walnut, CA (US); Sheng Wu, Arcadia, CA (US); Andrew C. Sneddon, Oklahoma City, OK (US); Andrei Deev, Pasadena, CA (US); Li Gao, Covina, CA (US)

(73) Assignees: GEOISOCHEM CORPORATION, Covina, CA (US); ARROWGRAND TECHNOLOGIES LLC, Covina, CA (US)

(21) Appl. No.: 15/211,469

(22) Filed: Jul. 15, 2016

(51) Int. Cl. E21B 49/00; E21B 47/06; G01V 11/00; E21B 49/08; E21B 21/06

(52) U.S. Cl. CPC E21B 49/005; G01V 11/002; E21B 49/08; E21B 47/06; E21B 21/067; E21B 21/065

(57) ABSTRACT

Methods and systems for assessing permeability, porosity, and production fluids pressure or analyzing reservoir fluids in connection with a drilling operation are provided, comprising collecting from a series of depths mud gas samples and reservoir cuttings of a minimum size; allowing the cuttings to evolve a headspace gas within one or more time delays to obtain headspace gas samples; determining within the time delay carbon isotope ratio differences between the mud gas and headspace gas samples; and identifying the depths having isotope ratio differences smaller than those from nearby depths.

The present invention relates to assessing the production fluids pressure, permeability and/or porosity of tight hydrocarbon-bearing reservoir formations, and in particular by means of stable isotope ratio and hydrocarbon concentration measurements, and using such as proxies in guiding drilling and production decisions and operations.

To be able to correctly estimate production fluids pressure, permeability, and porosity from relatively limited measurements, including of isotope ratio values, is a significant and ongoing challenge in oil and gas geological prospecting and related industries of geological and geochemical analysis, as its success can in turn lead to the correct selection of horizontal drilling positions and fracture intervals and the making of other production and evaluation decisions.

Well site mud logging can provide a zone-by-zone assessment of pressure and porosity, the latter extrapolated, among other parameters. Permeability, a further interpreted or extrapolated parameter, can also be provided. Current methodologies are based on conventional petrophysical models, however, and often difficult or impossible to apply for tight reservoirs or other unconventional petroleum systems. We provide a new method for near real-time assessment of these parameters suited for tight or unconventional reservoirs. Petroleum geologists would benefit from a new data dimension and a new interpretive aid.

Porosity and permeability are important parameters in geology and geochemistry. While the former is a measure of how much of a rock is open space, which can be between grains or within cracks or cavities of the rock, the latter is a measure of the ease with which a fluid can move through s porous matrix of the rock. The fluid can be gas or liquid, and it can be foreign or trapped, for example hydrocarbons or connate fluids. Permeability is an approximate measure of connectivity. Porosity and permeability are related characteristics, but not related linearly nor clearly in all regimes. Permeability in particular is important in determining how easily hydrocarbons can be produced from a particular formation, especially tight formations. Tight formations are those with low permeability (e.g., 0.1 mD or less), sometimes very low permeability (e.g., 0.01 mD or less), and include shale and tight sandstones. Permeability is used in geophysical models and sometimes directly to guide production and evaluation decisions and treatments, and to estimate production potential. Treatments include stimulation and hydraulic and other fracturing operations.

For purposes of hydrocarbon production, it is necessary that there be sufficiently high production fluids pressure in order for production to occur. Production fluids broadly are those fluids recovered from the wellbore during drilling operations. Ideally the fluids comprise substantially hydrocarbons, which can be gas or liquid hydrocarbons. Production fluids pressure reflects especially the pressure of methane, ethane, and propane residing within the reservoir's rock matrix pores, but higher hydrocarbons, for example C4-C9, make a contribution also.

Isotope ratios have been used as proxies or markers for other reservoir characteristics or properties. The measurement of stable carbon isotope ratios, especially of methane (C1) but also ethane and propane (C2 and C3) and higher hydrocarbons, is an established geochemical technique. A measure of the ¹³C to ¹²C ratio is termed δ¹³C and reported in parts per thousand (or per mil, ‰) according to standard geochemical definition, and written as d13C herein out of convenience, hence d13C_{C1} for δ¹³C of C1 or methane. A difference between two δ¹³C values is commonly written as Δδ¹³C, and will be written as dd13C herein out of convenience.

During mud logging for drilling and production, and for testing and evaluation, drilling mud gas is collected, often in tubes (e.g. IsoTubes from Isotech Laboratories, Inc.). Pulverized reservoir rock cuttings are also collected. Cuttings are collected into jars, bottles, or other containers (e.g. IsoJars from Isotech Laboratories, Inc.), where the gas that is allowed to evolve from the cuttings into the headspace of sealed jars is termed headspace gas. Mud gas is sometimes characterized as substantially comprising free, solution, or lost gas, while headspace gas as substantially comprising adsorbed gas that is desorbed.

Methods and systems for compositional and isotope analysis of injection and production fluids are disclosed in U.S. Patent Publ. Nos. 2005/0252286 and 2008/0099241, which are incorporated herein by reference. These and other art references disclose that composition and isotope information from fluid characterization may be used to “fingerprint,” or identify the produced effluent from each zone of the reservoir, and thereby provide improved correlation of productivity for the zones; that the proportion in the produced effluent from each zone may be linked to the flow rate for each zone by measuring the mix composition and using the composition from each zone to determine the flow rate from each zone; and that compositional and isotope analysis may aid in distinguishing zones in the well, in correlating the zones of the well with those of other wells, and in understanding the origin of the reservoir fluids; and further that a fluid characterization unit may aid in defining the completion mechanism for the well and in correlating cuttings with specific zones of the reservoir.

Conventional mud logging focuses on gases and very light hydrocarbons from the headspace of mud beaters, or mud gas—distinct from the headspace gas evolved from cuttings in jars or bottles—though cuttings evolved gases are also examined. However, for tight resources such as shale oil and gas, hydrocarbons are trapped inside tiny pores scattered throughout the reservoir rocks. These hydrocarbons are not immediately released into the drilling mud, but only released hours or even days later. Thus conventional mud gas analysis cannot accurately reflect the availability of trapped hydrocarbons. Additionally, oil produced from tight formations are mainly light hydrocarbons C1-C15, which will be lost from cutting chips if not analyzed immediately. The speed or dynamics of release as revealed by parameters of gas evolved from cuttings securely sealed, and within a time delay, alone or in comparison to mud or free gas, provides important and identifying information that will aid drilling and production decisions.

We have discovered that, if headspace gas evolution and isotope ratio determination are carried out within a specific window of time, production fluids pressure, permeability, and porosity can unexpectedly be assessed by measuring the carbon isotope ratio differences between mud gas and cuttings headspace gas from each of a depth series. Beyond this window, isotope ratios and other information obtained will be difficult or confusing to interpret, and not as useful in guiding drilling and production decisions. Certain rates of change of isotope ratios or concentrations over time are also useful. These aspects concerning the criticality of time and the rates of change over time are not previously appreciated.

Further, there is little isotopic fractionation at high pressures, as occurs when gas or petroleum is produced, as noted earlier, or when permeability is high, thus isotope ratio measurements would be uninformative regarding flow properties under such conditions. Tight formations however have both small pore sizes and hence low permeability, and also generally lower pressures. When using isotope ratio or hydrocarbon concentration measurements as proxies for assessing flow properties and pressures suited for production in a tight formation, production fluids pressure, permeability, and porosity should be assessed together, because they are inseparably related. However, assessments and proxies remain largely phenomenological, with detailed mechanisms unavailable.

An aspect of the inventive method relies on measuring isotope ratios of headspace gas evolved from reservoir rock cuttings. Art references do not place requirements on rock cuttings size. For the present invention, however, rock cuttings are required to be of a specific minimum size. Only those meeting this specific minimum size can reveal gas molecules degassing or desorbing through a representative and layered connectivity during headspace gas evolution, and stand as fairly accurate proxies for production fluids pressure, permeability, and porosity characteristics.

Regarding which zones are of relative high permeability, porosity, and production fluids pressure, as proxied by methane carbon isotope ratio differences between mud gas and cuttings evolved gas, our inventive method is based on a conclusion opposite to that by prior art references. Art references teach that larger differences between tube (mud gas) and jar (headspace gas) d13C_{C1} values correlate with increased permeability. See, for example, “Gas Character Anomalies Found in Highly Productive Shale Gas Wells” by Ferworn, K., et al. (2008), an abstract of the same title by Zumberge, J. E., et al. for the Goldschmidt Conference (2009), and “Environmental, Exploration and Production Applications of Shale Gas Analyses” by Pirkle, R. J. and McLoughlin, P. (2012).

### DESCRIPTION OF THE DRAWINGS

FIG. 1 is a C1 concentration and d13C_{C1} vs. depth plot for both mud gas and headspace gas from a shale well.

FIG. 2 illustrates a hydrocarbon concentration vs. time plot for three instances.

FIG. 3 illustrates an embodiment system that executes the inventive methods to assess zones of relative high permeability, porosity, and production fluids pressure in connection with drilling and production operations. Elements not part of the inventive system though interacting with it are shown to facilitate understanding.

While the invention is susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents, and alternatives falling within the spirit and scope of the invention as defined by the appended claims.

### DESCRIPTION OF ILLUSTRATIVE EMBODIMENTS

Illustrative embodiments of the invention are described below as they might be employed in assessment and analysis methods in connection with drilling and hydrocarbon production, and systems implementing the same. In the interest of clarity, not all features of an actual implementation are described in this specification. It will of course be appreciated that in the development of any such actual embodiment, numerous implementation-specific decisions must be made to achieve the developers' specific goals, which will vary from one implementation to another. Moreover, it will be appreciated that such a development effort might be complex and time-consuming, but would nevertheless be a routine undertaking for those of ordinary skill in the art having the benefit of this disclosure. Further aspects and advantages of the various embodiments of the invention will become apparent from consideration of the following description.

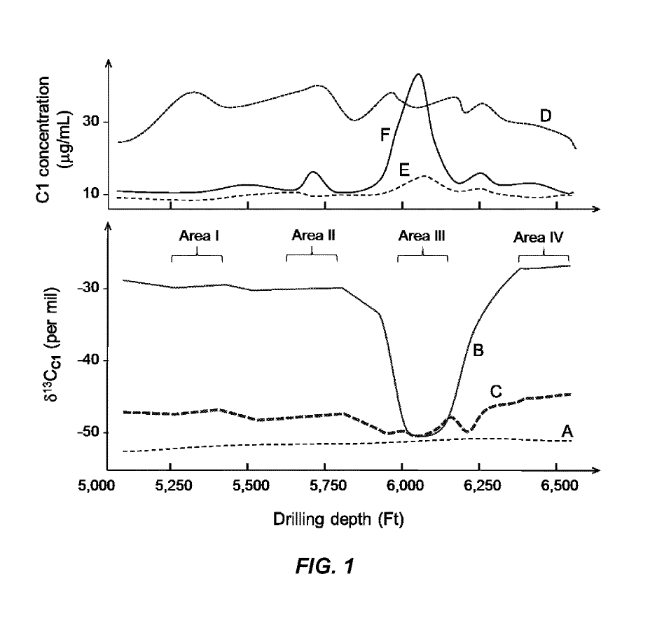

A method for ascertaining zones of relative high permeability, porosity, and production fluids pressure in connection with a drilling operation is provided as an embodiment of the present invention. The method comprises collecting from each of a series of depths one or more mud gas samples and one or more samples of reservoir cuttings; allowing the one or more cuttings samples to evolve a headspace gas within a specific time delay, obtaining one or more respective headspace gas samples; determining, within the time delay, at least one carbon isotope ratio difference dd13C between the mud gas samples and the headspace gas samples from each of the depths; and identifying the depths having dd13C values smaller than those from nearby depths. Those depths identified as having relatively smaller dd13C values than their neighboring depths are depths of interest, and indicate zones of relative high permeability, porosity, and production fluids pressure. FIG. 1 is a C1 isotope ratio (and concentration) vs. depth plot for both mud gas and headspace gas from a shale well, and will be described in detail below in Example 1.

In some embodiments, the time delay by which headspace gas is allowed to evolve from the cuttings and isotope ratios measured is 48 hours, 24 hours, 12 hours, or 6 hours, or a time interval between any two of these. In another embodiment, the time delay is 6 hours or less, or alternatively 5, 4, 3, 2, or 1 hour(s), or any time interval between any two of these values. In certain embodiments, several measurements (including of d13C or hydrocarbon concentration), up to 2, 3, 4, or 5, of the same sample are determined with different delays, with however at least one taken within 24 hours, or 12 or 6 hours.

Samples from a series of depths must be measured with the same or a similar time delay from collecting as each other. For example, if from depths x, x+1, x+2 samples A, B, and C are collected at about 6 am, 6:15 am, and 6:30 am respectively, and A is measured at 12 pm, a 6-hour time of delay from its collection, then B must be measured at 12:15 pm and C at 12:30 pm, with however an allowed deviation of up to 3 hours plus or minus, or up to 2.5, 2, 1.5, or 1 hour(s), or any in between these values. For example, in event of a 1-hour deviation, B can be measured between 11:15 am and 1:15 pm, and C between 11:30 am and 1:30 pm. In such a case, the time delays are sufficiently similar. To conduct timely measurements, samples can be withdrawn at a given time and transferred into a tube, e.g. a vacuum container for blood samples or a water displacement transfer tube.

In one embodiment, only d13C values for headspace gas samples from a depth series are measured within one time delay, while the mud gas d13C measurements are taken with a different time delay. Mud gas d13C values from a depth series often but not always vary significantly less than do headspace gas d13C values from a depth series. Thus for mud gas d13C, a value taken at one time delay may serve as an approximate stand in for a value at another, up to several days (if precautions are taken to not let the sample easily fractionate after collection), or even also from one depth for another.

Headspace gas can be evolved from the reservoir cuttings by at least one of crushing, agitating, and heating the cuttings. Cuttings may be immersed in water or other fluids while allowed to evolve headspace gas in sealed jars. Recovery of cuttings and obtaining cuttings fluids are further described in U.S. Patent Publ. No. 2005/0252286.

In the present invention, rock cuttings are of a size greater than at least 1 mm. In one embodiment, they are of a size greater than at least 2, 3, 4, or 5 mm, or a size between any two of these. Formation drill cuttings or chips may be sieved. In certain embodiments, the rock cuttings from which headspace gas is evolved are at least of a size as to be retained by a U.S. mesh-18 screen, or alternatively by a U.S. mesh-16, 14, 12, 10, 8, 7, or 6, or coarser screen. Tyler screens providing equivalent sizing may be also be used.

The carbon isotope ratios d13C's measured and the isotope ratio differences dd13C's subsequently determined for the present invention can be—from each depth—for at least one of methane (C1) to nonane (C9). In one embodiment, it is C1, and in another C2 or C3, and in another both C2 and C3, and in yet another C1, C2, and C3. In oil rich tight formations, isotope ratios and isotope ratio differences determined for a depth series are for any of C3-C9 in one embodiment, or C4-C9 in another.

Samples can be collected from a substantially regular series of depths, where “substantially regular” means depths spanning a stated interval—being about 10 feet, or any from 5 to 200 feet—plus or minus 10 feet.

In various embodiments, a depth having the smallest dd13C value among those of several depths before and after generally is a depth of interest. Deviations are permitted, such that the dd13C of a zone of actual relative high permeability, porosity, and production fluids pressure can differ from the smallest dd13C among the several neighboring depths, by 10 per mil, or 8, 6, 5, 4, 3, 2, 1, or 0.5 per mil, or any in between any of these values. The intervals between the depths can be any from 5 to 100 feet. The several depths before said depth of interest can be about 1 to 5 in number, and the same for after. One skilled in the art will however appreciate that when variations in d13C and concentration are especially small, one can look beyond 5 depths. This description of the depth intervals and number of neighboring depths in a region to examine holds for determining C1-C9 concentrations and identifying relatively greater rates of change thereof.

In an embodiment, the steps of collecting mud gas and cuttings samples, allowing the evolution of headspace gas from cuttings, determining isotope ratios, hydrocarbon concentrations, pressures (which directly correlates with concentration for lower hydrocarbons), or other parameters, as well as differences (between mud gas and headspace gas) or rates of change thereof, and subsequently identifying smaller dd13C values or greater rates of change in hydrocarbon concentrations of those among nearby depths are carried out while the drilling operation or hydrocarbon production is ongoing, so that such parameters can be assessed near real-time as in traditional mud logging. Another embodiment comprises a system comprising an analyzer system for implementing or executing the inventive method. The analyzer system may execute analysis off site or onsite, but preferably onsite. An analyzer system making use of a particularly suitable field-deployable and robust gas chromatography infrared spectroscopy (“GCIR”) detection system for isotope measurements will be described below.

Composition, including especially hydrocarbon composition, of either mud gas or headspace samples or both at various time points can be determined within the time delays described herein, in place of or in addition to isotope determination, where said composition serves as an analytical aid in assessing zones of production fluids pressure, or formation permeability or porosity. Composition providing relative or absolute concentrations of C1 to C9 are of interest, but those of higher hydrocarbons are not excluded. Higher concentration or greater rates of change are markers for higher production fluids pressure, formation permeability, or porosity relative to neighboring nearby depths.

Embodiments of the invention can further comprise one or more of: at least one of time and depth stamping cuttings; determining a cuttings lag time based on at least one of time and depth stamping cuttings; and determining productivity of the reservoir based on the cuttings lag time.

In one embodiment, we disclose a method for analyzing reservoir fluids in connection with drilling operations, which comprises determining a composition and isotopes of a headspace gas of cuttings fluids associated with a reservoir during a drilling operation, within a time delay of 6 hours or less from collecting cuttings from which the cuttings fluids are recovered, wherein the cuttings are of a size of about 3 mm or greater; and characterizing the reservoir fluids based on the composition and isotopes of the headspace gas of the cuttings fluids.

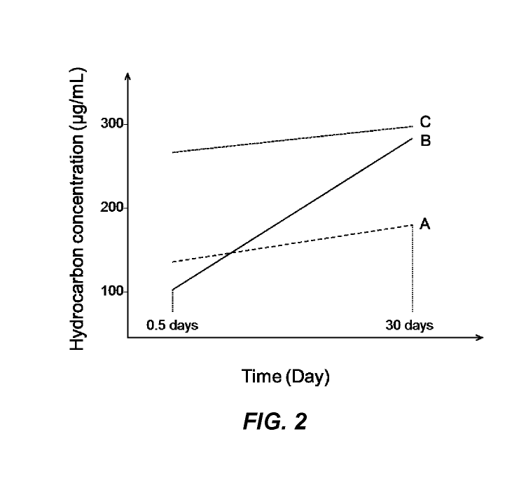

A higher absolute concentration after many weeks or months of release from cuttings can more reliably model higher production fluids pressure. But drilling decisions often must be made within hours to days (depending on approach and the specific stage of a drilling operation). In this earlier time frame, single-point concentration readings by themselves as proxy for permeability or porosity can be misleading. For example, in the illustrative FIG. 2, curve B's lower starting point than A is generally taken to reflect a higher permeability, favored for drilling. Yet B reaches a much higher ultimate concentration than does A, reflecting the higher production fluids pressure and reserve of the formation segment associated with the headspace gas sample described by B. We find that both permeability and production fluids pressure need to be taken into account in drilling and completion decisions, and the concentration kinetics can advantageously reveal contributions made by both, even within an earlier time frame. A very high concentration at an early time point, as exhibited by curve C, signals an altogether different regime, that of the classic sweet spot, no matter the rate of change. In our inventive method, for tight formations, kinetics of headspace gas samples is discriminatory of both permeability/porosity and production fluids pressures associated thereof, including within a relatively early time frame, and aid drilling and production decisions related to them. Comparison of rates of concentration change or speed of release is more discriminatory than of concentrations by themselves. For very tight formations, the analysis window is longer. It is known that productivity index (PI) and inflow production rate (IPR) curves may be generated based on permeability, and extrapolation of IPR curves may determine virgin reservoir pressure. However, the art does not teach how, in this context, to estimate permeability when permeability is not known, and how composition kinetics, especially of cuttings headspace gas, can be used in an early time frame.

In an embodiment, a method for using gas evolved from reservoir cuttings to aid drilling decisions in connection with hydrocarbon production comprises: collecting from each of a series of depths one or more samples of reservoir cuttings, wherein the cuttings are of a size of about 1 mm or greater; allowing the one or more cuttings samples to evolve a headspace gas to obtain one or more respective headspace gas samples, each with headspace gas evolution discontinued at two or more time points, wherein at least one time point for discontinuing evolution is within 12 hours after collecting, and at least a second time point for discontinuing evolution is more than 12 hours after collecting; determining, within no more than one hour after discontinuing headspace gas evolution, concentrations for at least one of C1 to C9 from each of the depths; and identifying the depths having rates of change of CX (X=1-9) concentrations over the two or more time points greater than those from nearby depths, whereby the depths of relatively greater rates of change are zones favored for further drilling, production, or exploration. For the at least one time point, evolution can also be discontinued within 10, 8, 6, or 4 hours after collecting, or any time between any of these. For the at least a second time point, evolution can be discontinued after 12 hours but within 4, 7, 14, 28, or 30 days after collecting, or any between any of these. When headspace gas evolution is discontinued and concentration measurements are taken at more than two points, the rate of change of concentration can be determined by fitting a line of best fit or regression line through the points, by any suitable method, on the concentration vs. time plot. In an embodiment, evolution is discontinued at least at one time point within 6 hours after collecting, and at a second after 12 hours but within 4, 7, or 14 days after collecting. Although U.S. Patent Publ. No. 2008/0099241, for example, discloses that ratios and trends of compositions versus time may be determined and plotted in fluid characterization. It does not disclose how ratios and trends of composition versus time assist specifically in making production decisions within a specific window of time.

In an embodiment, the method further comprises grinding the cuttings to a size smaller than 1 mm under sealed conditions such as to shorten the analysis window to 30 days or less. For example, grinding can be carried out by means of a magnetically coupled blade or agitator under sealed conditions. Applied in this manner, more than 50% of cuttings having a size of 3 mm or greater can be ground down to 0.3 mm or smaller in less than 10 min, thus speeding up release. The grinding can also be carried out by means of incorporating cuttings in jars sealed together with heavy metal objects, which when shaken or vibrated smash and shatter the cuttings, resulting in faster generation of fine particles in a short period of time. Independently, in an aspect, in order to speed up release of hydrocarbons, e.g. C5 and above, having boiling points above the typical room temperature, cuttings jars can be heated, for example to about 90° C. After cuttings are reduced into much smaller pieces, the second or final time point for discontinuing headspace gas evolution can be within 30 days to give a quantity of hydrocarbons close to the ultimate amount contained in the cuttings (for a given volume). To the extent the cuttings hold different isotopologue populations, further grinding as described herein also permits d13C measurements that can reflect a complete mixture of such populations more quickly. Selecting or sifting for cuttings having a size less than 1 mm from the circulating mud does not achieve the intended purpose described in this paragraph. The grinding under sealed conditions described herein is further to collecting reservoir cuttings of a size of about 1 mm or greater, and generating from such coarser particles finer ones. Grinding means or heating aids are further constituent elements of the present inventive system that implements the inventive methods. In particular, the drilling sample processing system described may comprise such grinding or heating means.

The inventive methods may be used at the stage of drilling pilot vertical wells into a target formation which pass through the sweet spot layer(s), after which the vertical is pulled, for example, one week later, for lateral drilling to land a target depth and region more precisely. Deciding the location to initiate lateral drilling is a time-critical decision, which should be made preferably sooner. The inventive methods may also be applied to assist in deciding where to stimulate, e.g. by hydraulic fracturing, after lateral drilling.

A method for ascertaining high production fluids pressure zones in connection with hydrocarbon production using methane carbon isotope ratio difference dd13C_{C1} as a proxy is disclosed, and comprises: determining, within a time delay of 6 hours or less of collecting reservoir cuttings from which can be evolved a headspace gas, a difference dd13C_{C1} between the methane carbon isotope ratio of the headspace gas and that of a mud gas from each of a series of drilling depths; and identifying the depths having small dd13C_{C1} values compared to those from nearby depths, whereby the depths of relatively smaller dd13C_{C1} values are taken to be zones of relatively higher production fluids pressure.

We also disclose a method for ascertaining high production fluids pressure zones in connection with hydrocarbon production using gas evolved from reservoir cuttings, comprising: collecting from each of a series of depths one or more samples of reservoir cuttings, wherein the cuttings are of a size greater than about 1 mm; allowing the one or more cuttings samples to evolve a headspace gas to obtain one or more respective headspace gas samples within a time delay of 12 hours or less of collecting; determining, within the time delay, a concentration for at least one of C1 to C9 from each of the depths; and identifying the depths having CX concentrations greater than those from nearby depths, X being any of 1-9, whereby the depths of relatively greater CX concentrations are taken to be zones of relatively higher production fluids pressure.

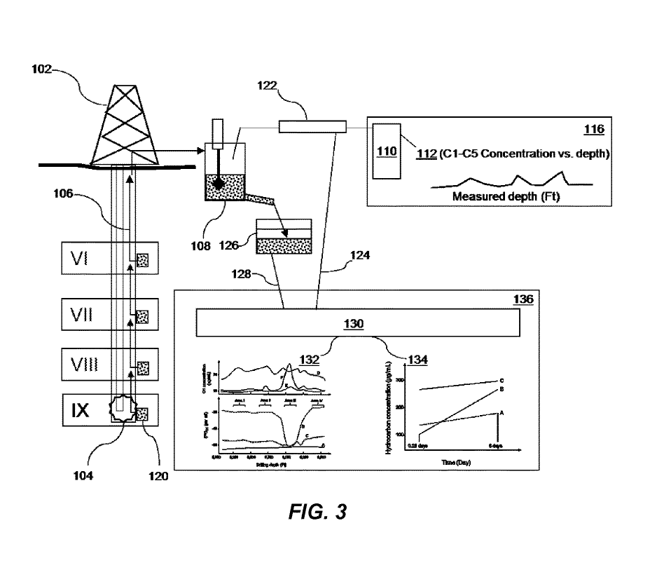

An embodiment of the present invention is a system that executes or implements the methods of assessment or reservoir fluids analysis as described herein. FIG. 3 illustrates elements of such a system in accordance with one embodiment, as well as their interaction with elements outside the system. Drill bit 104 breaches and crushes reservoir rocks in the formation at a specific drilling depth (e.g. depth IX, one of a series VI to IX), and the cuttings 120 are pumped upwards the rig 102 by circulating mud 106 and collected at the surface by a mud beater 108, where cuttings 120 are trapped and agitated for a short time before being discharged, releasing into the mud beater headspace gases, termed mud gas. The inventive system comprises a sampling tube or loop 122 that collects mud gas without interrupting its transfer to a conventional analyzer 116 (not part of the inventive system, but shown for comparison); a sampling jar 126, by which fresh cuttings immediately rolling off the mud beater 108 are collected, sealed, and allowed to evolve headspace gas; a first transfer means 124 by which mud gas from 122 and a second transfer means 128 by which headspace gas from 126 are transferred or introduced to a field-deployable analyzer system 130 capable of (preferably onsite) analysis, producing a log 132 of isotope measurements, and measurements 134 of hydrocarbon concentration(s) (in a time-dependent manner in one embodiment). In an embodiment, the analyzer system analyzes gases and light hydrocarbons C1 to C9 released within hours to several days from cuttings being collected and sealed in jar 126. Elements 130, 132, and 134 together comprise an arrangement 136, an analyzer system and certain of its outputs. Arrangement 136 may contain other components not pictured.

In conventional well logging, by comparison, mud beater headspace gas (or mud gas) is monitored by a gas monitor 110, resulting in a log 112 of mud gas composition, especially C1 to C5 concentrations, by depth. Elements 110 and 112 comprise an arrangement 116, a conventional analyzer and certain of its outputs. Arrangement 116 may contain other components not pictured.

A system that implements or carries out the methods described herein comprises a sample tube in which a mud gas sample is collected or a sample loop through which the mud gas sample is transferred directly to an analyzer system (the sample tube or loop element being absent, if only cuttings are collected and headspace gas samples evolved and introduced to the analyzer in a particular embodiment); a jar in which samples of reservoir cuttings, of a size of about 1 mm or greater, are collected and allowed to evolve headspace gas, giving a headspace gas sample; wherein mud gas or cuttings are collected from each of a series of depths; transfer means for introducing the mud gas or headspace gas sample into the analyzer system, non-limiting examples of such means being transfer tubes and/or gas syringes; an analyzer system capable of analysis (preferably a field-deployable analyzer system capable of onsite analysis) of at least one of carbon isotope ratios d13C for C1 to C3 and optionally hydrocarbon concentrations for C1 to C9, whereby within certain time delays and/or discontinuing headspace gas evolution, at least one of carbon isotope ratio differences from dd13C_{C1} to dd13C_{C3} between the mud gas and headspace gas samples and/or concentrations for at least one of C1 to C9 from each of the depths are determined, and based on comparing dd13C_{CX} values (dd13C_{CX}=any from dd13C_{C1} to dd13C_{C9}), or concentrations, or rates of change in concentration for CX (X=1-9) over two or more time points, with values of similar parameters from nearby depths, depths of relatively higher permeability, porosity, or production fluids pressures are identified to aid drilling and production decisions. In an embodiment, the cuttings may be mechanically sampled.

In an embodiment, the analyzer system can analyze carbon isotope ratios d13C beyond C3. In an embodiment, the system is used for analyzing or characterizing reservoir fluids based on the composition and isotopes of the headspace gas of cuttings fluids associated with a reservoir, wherein the cuttings are of a size of 3 mm or greater. In another embodiment, the system is used for assessing permeability and production fluids pressure in connection with hydrocarbon production using gas evolved from reservoir cuttings, wherein concentrations for at least one of C1 to C9 from each depths of headspace gas evolved from cuttings in the jar are determined within no more than one hour after discontinuing evolution, and whereby the depths of relatively greater rates of change are zones favored for further drilling, production, or exploration.

As used herein, “onsite” means capable of being set up in the near vicinity of a drilling rig from which mud gas samples and cuttings are collected or retrieved, and not in a distant laboratory. As applied to the analyzer system, “field-deployable” means providing results onsite with at least such reproducibility as would be found comparable, by one skilled in the art, to those by standard instruments (GC-MS, usually) stationed inside laboratory buildings. Preferably the analyzer system has a small footprint and/or is light. Field samples, either mud gas or especially evolved headspace gas, may be difficult to obtain or of small volume. Preferably the analyzer system detects constituents in small-volume or low-flow samples while maintaining high optical spectroscopy and temporal resolution, without the aid of any makeup gases. In a preferred embodiment, the analyzer system comprises a pressure-flow control device, which further comprises at least one of a pressure sensor, an electronic or computer control loop, and electronically actuated values. The valves adjust pressure or flow conditions as instructed by the electronic or computer control loop, based on an initial pressure detected by the pressure sensor. In an embodiment, the analyzer system comprises a hollow waveguide (“HWG”), and by means of the pressure-flow control device can stabilize a pressure at the waveguide inlet (the pressure-flow control device and the HWG at its outlet being coupled by a dead volume-minimizing coupler that transmits flow (back) to the HWG inlet, as adjusted by the aforementioned valves, with very little loss, thus ensuring transmission accuracy and speed) at a value between about 10 Torr and about 200 Torr, such as to permit a sufficiently high spectroscopic resolution of 0.05 cm⁻¹ or lower.

The analyzer system disclosed herein detects with high resolution one or more constituents in a sample, preferably a gas sample. The analyzer system comprises physical components that include a light source for generating a light beam; an HWG for transmitting the light beam and the sample, the waveguide having a gas inlet and a gas outlet; a detector that detects absorption peaks associated with the sample constituents; dead volume-minimizing couplers at the HWG inlet (coupling tightly sample introduction component to the waveguide) and HWG outlet (described above); and a temperature controlling device for maintaining the waveguide at a stable temperature. The waveguide has a diameter D that is less than 2 mm and a length that is between 0.2 meters and 3 meters. Advantageously, the analyzer system handles well a small-volume or low-flow gas sample as detailed in the paragraph below, where “low-flow” refers to a continuous flow rate of about 5 mL/min or less. About 1 mL or less, e.g., is considered a small volume, and the analyzer system described herein handles well volumes as small as 0.01 mL or less. Constituents can be detected with a spectroscopic resolution of about 0.05 cm⁻¹ or better, preferably 0.01 cm⁻¹ or better. In embodiments of the system comprising a gas chromatograph (“GC”), a sample residence time of 1 second or less (refresh rate 1 Hz or greater), or preferably 0.25 second or less (refresh rate 4 Hz or greater), can be achieved, comfortably translating into a sufficiently high chromatographic resolution vis a vis the GC for it to distinguish constituent peaks under routine analysis conditions described herein. The term “high resolution” as used herein refers to both senses of “resolution”: spectroscopic, as well as chromatographic as supported by the sample residence time/refresh rate achievable by the analyzer system. The GC requires a carrier gas, but in an embodiment, the eluates are transported directly to the sample introduction system of the isotope analyzer to be analyzed without makeup gas.

The ability to quickly (i.e., with a refresh rate or response time of 1 sec or much less) and directly analyze a small-volume or low-flow gas sample without the use of make-up gas is a great convenience if a gas sample has been subject to separation by GC, which is necessary for mixtures. U.S. Patent Publ. No. 2010/0055802, for example, describes quantitative measurements of trace species after separation by cavity enhanced optical detection (CEOD) or cavity ring-down spectroscopy (CRDS), where however the addition of nitrogen to the separated and chemically converted species is required because the CRDS device requires a gas flow about 8 times higher than the optimal flow rate required for good GC separation of low molecular weight hydrocarbon constitutes in a sample. In contrast, the analyzer system described herein obviates the need for make-up gases, avoiding sample constituent dilution, which is especially advantageous for constituents already present at very low concentrations, for which any dilution will limit sensitivity. Cuttings-evolved headspace gas can have lower hydrocarbon concentrations than does mud gas. And when evolution is discontinued early for early analysis, headspace gas constituent concentrations can be very low, about several μg/mL or lower. CEOD, CRDS, and other cavity systems are not excluded from embodiments, but not most preferred.

Embodiments of the analyzer system comprising a GC component are capable of measuring sample constituents comprising CO₂ or H₂O having at least isotopologues ¹²CO₂ and ¹³CO₂, or ¹H₂O and ²H₂O, respectively, or both. One or more of ratios of such isotopologues can be calculated.

Several elements enable a field deployable embodiment of the present analyzer system, especially for isotope ratio analysis, and more specifically compound specific isotope analysis (CSIA). Compared to the industry standard GC-MS instrumentation used in isotope analysis, a technology based on infrared (spectroscopy) (“IR”) is inherently much more stable long term, as shown in particular by not requiring calibration for months at a time in the field. This is why GC-MS has never been routinely adopted for field analysis. Studies demonstrating IR's inherent long-term stability include Tuzson, B. et al., Infrared Physics & Technology, 2008, 51: pp. 198-206; and Friedrichs, G. et al., Limnology & Oceanography: Methods, 2010, 8: pp. 539-51. With respect to power usage and weight, the analyzer system disclosed herein has a clear advantage compared to existing IR-based instruments, for example those based on CRDS or integrated cavity output spectroscopy (ICOS): a pump used in the analyzer system, accounting for a significant percentage of overall power consumption and weight of the system, is about 10 W or less and 0.5 kg or less, respectively, for of the system described herein, or preferably 5 W or less and 0.2 kg or less; current systems and units based on other types of spectroscopy all have greater power demand and weight. The present analyzer system's ability to directly handle small-volume or low-flow sample with fast response time yet without incurring dilution, as have been mentioned, are additional favorable factors enabling field deployability.

In accordance with one embodiment, a system for analysis (preferably an onsite system) of reservoir fluids during drilling operations comprises: a drilling sample processing system; and an analyzer system coupled to the drilling sample processing system, wherein the processing system recovers mud gas samples and reservoir cuttings of a size of about 1 mm or greater, and generates cuttings headspace gas samples from the cuttings within one or more time delays. The analysis system (preferably onsite) comprises an optional injection system; and an optional production system. The analyzer system comprises an isotope analyzer (preferably non-mass spectrometry-based), and an optional compositional analyzer, for geochemically analyzing fluids. The isotope analyzer can be IR-based. In an embodiment, the isotope analyzer comprises a hollow waveguide (“HWG”). The analyzer system is operable to analyze, within the time delays, reservoir fluids of a reservoir intersected by the drilling operation based on geochemical analysis of samples processed by the drilling sample processing system, and the optional injection and production systems, such as to identify zones of high permeability, porosity, and production fluids pressure. Time delays are those as in the related method embodiments.

The drilling sample processing system comprises sampling implements suitable for recovering mud gas and cuttings and for permitting headspace gas evolution under a sealed environment, including any suitable mud sampling tubes or sampling jars. Fluids evolved out of cuttings are cuttings fluids, which may be liquid or gas. Headspace gas is an example of cuttings fluids. The processing system also comprises sifting or sieving devices, for example metal meshes, for sifting or sieving cuttings based on particle size. The processing system can comprise transferring or coupling means to the analyzer system and to other components within the (preferably onsite) analysis system. Solid formation cuttings separated by a separator from the production fluid are disposed of in a waste pit. The drilling sample processing system may be coupled to the waste line and either manually or automatically controlled to sample cuttings. In an embodiment, the cuttings may be mechanically sampled.

In an embodiment, the isotope analyzer comprises a light source; an HWG having a diameter D less than 2 mm, and a length L between 0.2 m and 3 m; a dead volume-minimizing coupler at the HWG inlet, coupling it to a sample introduction system; a second dead volume-minimizing coupler at the HWG outlet; a temperature controlling device, which in an embodiment envelops a HWG housing that houses the HWG; and, coupled by the second coupler to the HWG outlet, a pressure-flow control device. In an embodiment, the pressure-flow control device comprises at least one of a pressure sensor, an electronic or computer control loop, and electronically actuated values, stabilizing a pressure at the waveguide inlet that reflects the pressure as adjusted by the pressure-flow control device through and aided especially by the dead volume-minimizing couplers.

Any suitable (preferably field-deployable) analyzer system or instrument capable of receiving mud gas and headspace gas samples and carrying out d13C and hydrocarbon concentration measurements (preferably onsite) within the one or more time delays specified herein may be incorporated as part of the inventive system. A non-limiting example of an analyzer system that aids the execution or implementation the inventive methods, being particularly suitable due to its (field) robustness, high optical spectroscopy and temporal resolution, and ability to detect constituents in small-volume or low-flow samples is that disclosed by U.S. Patent Publ. No. 2013/0058830 to Wu et al, which is incorporated by reference herein in its entirety.

In order to demonstrate that methods of the present invention are effective in ascertaining a zone of relative high production fluids pressure, permeability and/or porosity of a rock matrix and in achieving other recited purposes, sampling, measurements, and identification were carried out as illustrated in the following examples. These examples are not intended to limit or define the entire scope of the invention.

### EXAMPLES

### Example 1

Samples are shale gas samples from vertical wells in the Marcellus Shale, Pa. For cuttings, after filling jars with water and sieved cuttings (U.S. No. 6) and sealing, weight and volume of the contents are measured and compared to before filling to determine the volume of the cuttings. In FIG. 1, in the lower graph, curve A plots d13C_{C1} values of mud gas collected in tubes vs. depth, and curves B and C plot d13C_{C1} values of headspace gases evolved in jars measured within time delays of, respectively, less than 12 hours and 6 days after sample collection. The upper graph shows C1 concentration vs. drilling depth. Curve D shows the concentrations of C1 in mud gas for the same sample characterized by the d13C_{C1} curve A. Due to unavoidable integration routinely applied to pipeline data (and also the fact that within a depth of e.g. 500 feet approaching a pay zone, mud gas hydrocarbon concentrations staying high), the mud gas concentration vs. depth plot has low contrast and is not valuable as a proxy by itself. Curves E and F show C1 concentrations for the same headspace gas samples characterized by curves B and C respectively.

Curve E shows that area III centered on a depth of 6,050 ft has a higher C1 concentration than nearby depths, confirmed unambiguously by Curve F, 6 days after sample collection and gas evolution. Yet curve B imparts the same information, clearly, in less than 12 hours. By day 6, headspace gas isotope ratio values at all depths displayed have lowered, as shown by curve C, uniformly approaching that of the mud gas, and C is no longer informative. Area III is interpreted to have higher permeability and holds a greater volume/pressure of gas than do areas I, II, and IV. To the extent greater porosity is correlated with greater permeability, Area III also has greater porosity than do nearby areas.

What is claimed is:

1. A method for ascertaining zones of relative high permeability, porosity, and production fluids pressure in connection with a drilling operation, comprising:
collecting from each of a series of depths one or more mud gas samples and one or more samples of reservoir cuttings, wherein the cuttings are of a size of about 1 mm or greater;
allowing the one or more cuttings samples to evolve a headspace gas to obtain one or more respective headspace gas samples within a time delay of 12 hours or less of collecting;
determining, within the time delay, at least one of carbon isotope ratio differences from dd13C_{C1} to dd13C_{C9} between the one or more mud gas samples and the one or more headspace gas samples from each of the depths; and
identifying the depths having dd13C_{CX} values smaller than those from nearby depths, where dd13C_{CX} is any from dd13C_{C1} to dd13C_{C9},
whereby said depths are zones of relative high permeability, porosity, and production fluids pressure.

2. The method of claim 1, further comprising collecting the mud gas and cuttings samples, allowing the cuttings samples to evolve the headspace gas, determining at least one of carbon isotope ratio differences from each of the depths, and identifying the depths having smaller dd13C_{CX} values during the drilling operation.

3. The method of claim 1, further comprising evolving the headspace gas from the reservoir cuttings samples by at least one of crushing, agitating, and heating the cuttings.

4. The method of claim 1, wherein the time delay is 6 hours or less of collecting.

5. The method of claim 1, wherein the cutting are of a size of about 3 mm or greater.

6. The method of claim 1, wherein at least one of the carbon isotope ratio differences determined is dd13C_{C1}, and wherein the dd13C_{CX} values identified are dd13C_{C1} values.

7. The method of claim 1, wherein at least one of the carbon isotope ratio differences determined is dd13C_{C2}, and wherein the dd13C_{CX} values identified are dd13C_{C2} values.

8. The method of claim 1, wherein at least one of the carbon isotope ratio differences determined is dd13C_{C3}, and wherein the dd13C_{CX} values identified are dd13C_{C3} values.

9. The method of claim 1, further comprising determining the composition of the one or more mud gas samples and headspace gas samples.

10. The method of claim 1, wherein the series of depths are substantially regular.

11. The method of claim 10, wherein the substantially regular series of depths are at about 10 feet intervals.

12. The method of claim 1, wherein the time delay is similar for all dd13C_{CX} values.

13. The method of claim 1, wherein identifying the depths having dd13C_{CX} values smaller than those from nearby depths comprises identifying depths having the smallest dd13C_{CX} values among at least several depths before and at least several after, wherein the depths are at about 50 feet intervals.

14. The method of claim 1, further comprising: at least one of time and depth stamping cuttings; determining a cuttings lag time based on the at least one of time and depth stamping cuttings; and determining productivity of the reservoir based on the cuttings lag time.

15. A method for analyzing reservoir fluids in connection with drilling operations, comprising:
determining a composition and isotopes of a headspace gas of cuttings fluids associated with a reservoir during a drilling operation, within a time delay of 6 hours or less from collecting cuttings from which the cuttings fluids are recovered, wherein the cuttings are of a size of about 3 mm or greater; and
characterizing the reservoir fluids based on the composition and isotopes of the headspace gas of the cuttings fluids.

16. A method for using gas evolved from reservoir cuttings to aid drilling decisions in connection with hydrocarbon production, comprising:
collecting from each of a series of depths one or more samples of reservoir cuttings, wherein the cuttings are of a size of about 1 mm or greater;
allowing the one or more cuttings samples to evolve a headspace gas to obtain one or more respective headspace gas samples, each with headspace gas evolution discontinued at two or more time points, wherein at least one time point for discontinuing evolution is within 12 hours after collecting, and at least a second time point for discontinuing evolution is more than 12 hours after collecting;
determining, within no more than one hour after discontinuing headspace gas evolution, concentrations for at least one of C1 to C9 from each of the depths; and
identifying the depths having rates of change of CX concentrations over the two or more time points greater than those from nearby depths, X being any of 1-9,
whereby the depths of relatively greater rates of change are zones favored for further drilling, production, or exploration.

17. The method of claim 16, wherein a concentration is determined for at least C1, and wherein the depths are identified by rates of change of C1 concentrations.

18. The method of claim 16, wherein the second time point for discontinuing headspace gas evolution is more than 12 hours but within 4 days after collecting.

19. The method of claim 16, wherein the second time point for discontinuing headspace gas evolution is more than 12 hours but within 30 days after collecting.

20. The method of claim 18, wherein the first time point for discontinuing headspace gas evolution is within 6 hours after collecting.

21. A method for ascertaining high production fluids pressure zones in connection with hydrocarbon production using methane carbon isotope ratio difference dd13C_{C1} as a proxy, comprising:
determining, within a time delay of 6 hours or less of collecting reservoir cuttings from which can be evolved a headspace gas, a difference dd13C_{C1} between the methane carbon isotope ratio of the headspace gas and that of a mud gas from each of a series of drilling depths; and
identifying the depths having small dd13C_{C1} values compared to those from nearby depths,
whereby the depths of relatively smaller dd13C_{C1} values are taken to be zones of relatively higher production fluids pressure.
